(19) United States
(12) Patent Application Publication
(10) Pub. No.: US 2011/0161094 A1
(43) Pub. Date: Jun. 30, 2011

(54) System and method for health care costs and outcomes modeling using dosage and routing pharmacy information

(75) Inventors: John F. Haughton, Winchester, MA (US); Yang Zhao, Cambridge, MA (US); Randall P. Ellis, Newton, MA (US); Arlene S. Ash, Boston, MA (US); Benjamin McMillan, Boston, MA (US); Bruce Bowen, Sisters, OR (US)

(73) Assignee: DXCG, Inc., Boston, MA (US)

(21) Appl. No.: 10/227,606

(22) Filed: Aug. 23, 2002

(51) Int. Cl. G06Q 50/00; G06Q 10/00

(52) U.S. Cl. 705/2

(57) ABSTRACT

A system for health care costs and outcomes modeling for members of a defined subject population using dosage and routing information is disclosed.

### BACKGROUND

1. Technical Field

This invention relates generally to the field of predictive modeling and more specifically to the field of modeling healthcare costs and outcomes using dosage and routing evaluative data and timing information.

2. Background

Traditional actuarial models of cost prediction, especially for health care, have typically not been as accurate or as helpful as desirable. Since most traditional actuarial methods of predicting medical costs were based purely on an economic model using standard demographic data about age and sex, they did not take into account how sick a patient or patient population might be, and hence often produced inaccurate results.

Some modeling and predictive techniques, such as neural nets, for example, can produce non-generalizable results. Even pure linear regression analysis techniques, while generalizable, do poorly particularly at extremes of low and high cost individuals.

Still other techniques for predicting or monitoring expenses attempt to measure the cost efficiency of health care providers using the concept of episodes or groups of services. In this approach, some diagnostic information from hospital and physician office settings are grouped, along with some prescription pharmacy data into a treatment window time period. Thus, an episode of bronchitis may be considered “over” if no further treatments have occurred within 60 days of the first diagnosis. If a patient is treated again for bronchitis within the 60 day period, it may represent an extension of the original time period or could be viewed as a flag to investigate the efficacy of treatments used. This approach tends to provide much more information about procedures and physician specialists than it does about many other factors critical to health care predictions, such as disease, severity, comorbid health conditions and complications, etc.

For example, if a 45-year old otherwise healthy female is treated for bronchitis and a 64 year old female with diagnoses of diabetes, emphysema, and osteoporotic fractures is treated for bronchitis, the expected cost of the episode of bronchitis for each may or may not be the same—the extra health-burden carried in the additional or co-morbid diagnoses of the 64-year old female may create an increased probability of a more severe (and more expensive to treat) episode of bronchitis than the 45-year old female if each gets the same respiratory infection or bronchitis. Additionally, the probability is significant that the 64-year old female will incur much more in costs overall in the next year because of her other health problems.

### DRAWINGS

FIG. 1 is a schematic drawing of the present invention.

FIG. 2 is a schematic drawing of the functional functions of the present invention.

FIG. 3 is a block diagram illustrating the application of grouping and modeling of the present invention.

FIG. 4 is a block diagram illustrating the application of grouping and modeling of the present invention for diagnostic conditions.

FIG. 5 is a block diagram of heart condition hierarchies according to the present invention.

FIG. 6 is a table showing pharmacy data0 used by the present invention.

FIG. 7 is a flow diagram of the importer function of the present invention.

FIG. 8 is a flow diagram of the grouper function of the present invention.

FIG. 9 is a flow diagram of the modeler function of the present invention.

FIG. 10 is a flow diagram of the reporter function of the present invention.

FIG. 11 is a schematic diagram of the present invention applied to scholastic achievement.

FIG. 12 is a block diagram illustrating the grouping and modeling of the present invention for pharmacy prescription information.

### DETAILED DESCRIPTION OF THE INVENTION

The present invention is a system for costs and outcomes modeling which can be used to predict costs and outcomes (or risk and severity adjustments for performance analysis purposes) using measurable patterns of evaluative data about a defined subject population, which include information about the absolute and relative timing of evaluation. While some of the embodiments shown are particular to the analysis of health care costs and outcomes for defined subject populations such as health care organization members using evaluative data such as diagnoses, pharmacy data, laboratory data, patient survey data, etc., those skilled in the art will appreciate that the invention can also be used with other types of evaluative data, such as socio-economic data, etc., to predict costs and outcomes.

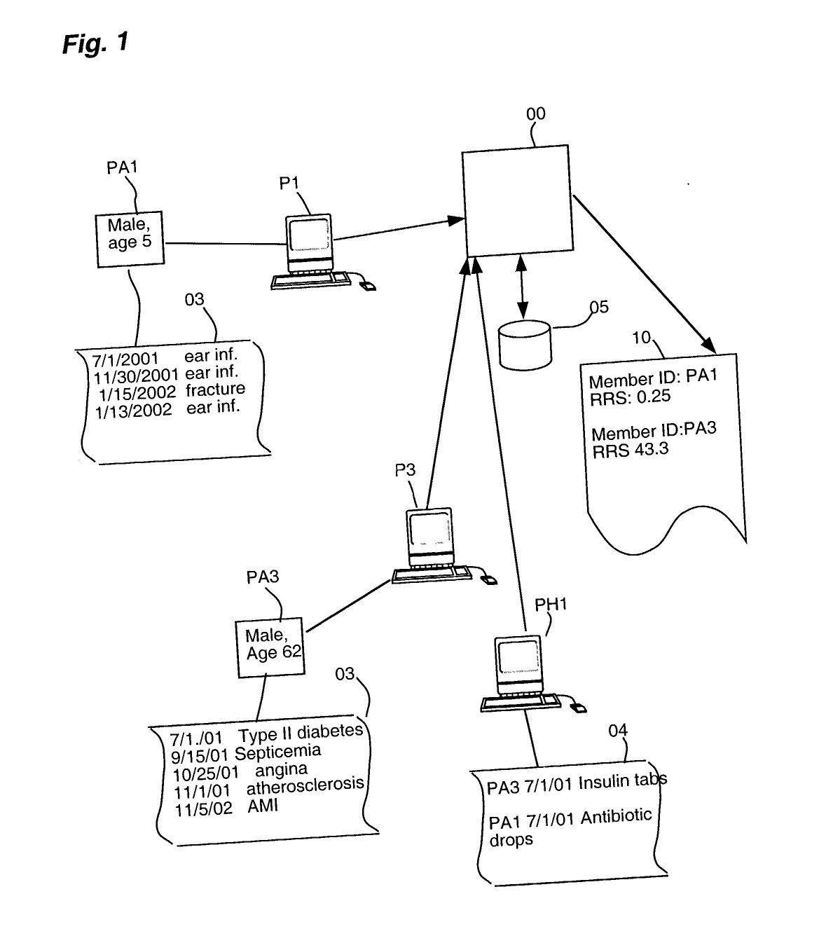

As seen in FIG. 1, the present invention is implemented on a computer system 00, which has storage capability 05 for storing, in one or more databases, evaluative data information about patients, diagnoses, pharmacy information, laboratory information, survey data and similar types of health care evaluative data information, in this example. In FIG. 1, information is shown being supplied to computer system 00 by three different sources: health care providers P1 and P2 and pharmacy PH1. In this example, the information supplied by provider P1 is date stamped diagnostic information 03 about diagnoses which provider P1 has made concerning patient PA1, a 5-year old male. Provider P2 is shown submitting date stamped diagnostic information 03 about diagnoses which provider P2 has made concerning patient PA3, a 62-year old male. Finally, pharmacy PH1 is depicted providing date stamped information about prescriptions filled for patients PA1 and PM. Using the present invention to analyze this kind of information which has been collected over time, reports 10 can be generated to predict health care costs for the present or a future period, and provide other features as well.

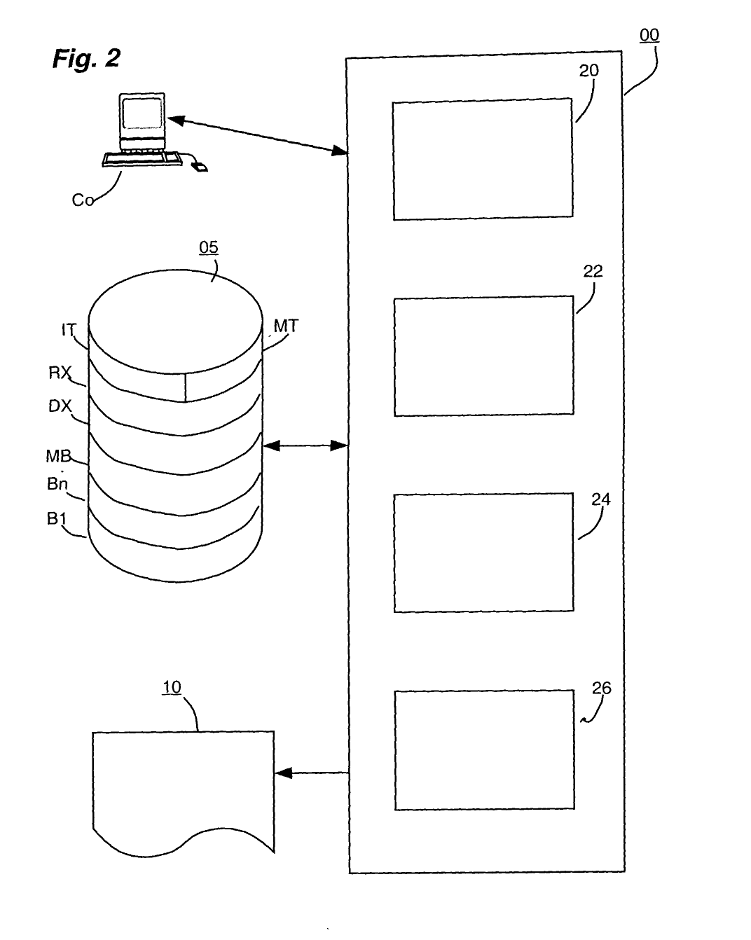

Referring now to FIG. 2, in the embodiments shown the present invention comprises two main functions—grouper 22 and modeler 24 and two auxiliary functions—importer 20, and reporter 26. As will be apparent to those skilled in the art, other organizations of the logic and functionality of the invention are possible without deviating from the spirit of the invention.

Still in FIG. 2, it can be seen that several databases are stored on storage device 05. In the health care embodiments shown, predictive modeling is done using diagnostic cost group modeling techniques, using evaluative data such as diagnostic data or pharmacy data or laboratory data, or demographic data or survey or patient reported data or combinations of these or similar types of evaluative data items which can be correlated or generalized. Predictive models using diagnostic cost information, known as diagnostic cost group (DCG™) models were originally developed to enable the Centers for Medicare and Medicaid Services, (CMS, formerly Health Care Finance Administration or HCFA) to health-risk adjust its payments to managed care organizations for Medicare beneficiaries. More recently, the DCG™ methodology was expanded by DxCG™, Inc. to include models for privately-insured (Commercial) and Medicaid populations.

These models are constructed using benchmark data containing derived cost weights for evaluative data items. The benchmark data is created by subjecting information about a pre-defined benchmark population to analytical techniques and storing the derived cost weights for each evaluative data item in a database B1. The health care embodiments shown use linear, additive formulas obtained from Ordinary Least Squares (OLS) regressions to combine the expenses associated with diagnostic groupings, age/sex cohorts and other demographic factors which are evaluative data items. Each diagnostic category, age/sex cohort, or demographic or other evaluative data item contributes a cost weight to the final prediction. As will be apparent to those skilled in the art, use of other analytic or modeling techniques (for example, neural network techniques, other linear regression techniques, transformation techniques, categorical techniques, probability techniques, logit techniques and higher-order non-linear techniques) can be used to derive the benchmark data and cost weights.

To illustrate the invention, the health care embodiments shown use benchmark databases B1-Bn derived from reference national data sets for each such population (Commercial, Medicare, and Medicaid, for example). Thus, users can assess illness burden in a population relative to a benchmark and “drill down” to learn differences in the prevalence of various diseases and conditions between the benchmark population and the client organization's member population.

The health care embodiments of the present invention also use pharmacy data, laboratory data, examination data, survey data or similar health care evaluative data items as input. In the embodiments shown, National Drug Codes from outpatient pharmacy data alone or in conjunction with diagnostic data are used to predict total health care costs.

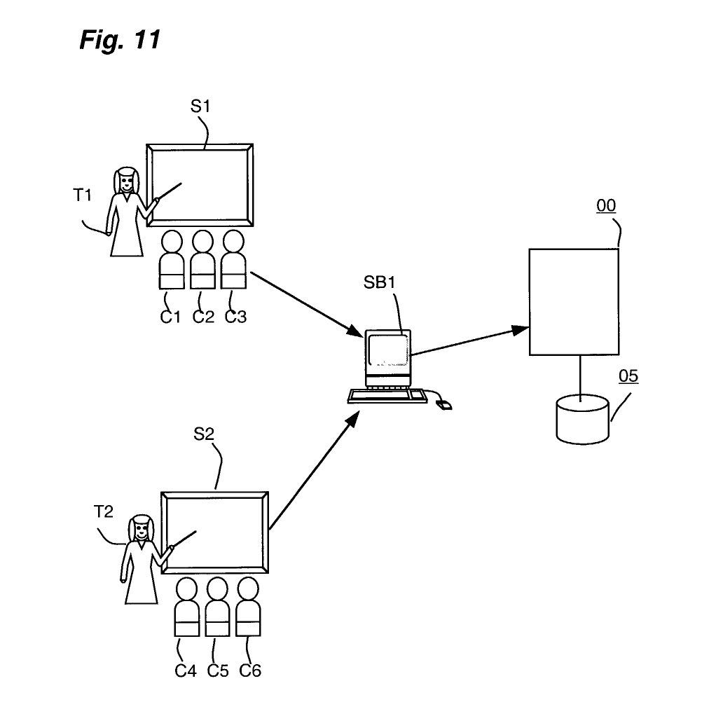

While the embodiments shown are directed primarily to modeling and predicting health care costs and outcomes, those skilled in the art will appreciate that the present invention can also be used for predicting costs and outcomes associated with other data subject to correlation and analysis, such as stock market prices, weather forecasting, credit worthiness, mortgage underwriting, and scholastic achievement, for example. As seen in FIG. 11, as quantifiable evaluative data items about a large representative population becomes available, any of a number of analytical techniques can be used to derive cost weights (or risk factors, in some cases) for the evaluative data items such as socioeconomic data, scholastic achievement and other factors. Then, evaluative data items can be grouped and modeled using the present invention to predict costs and outcomes. The present invention allows experienced practitioners in the field being evaluated to define and include interaction terms IT and timing terms MT (each of which is discussed in more detail below) that help increase the accuracy and stability of the models.

In the embodiments shown, for health care applications, the present invention uses the International Classification of Diseases, Ninth Revision, Clinical Modification (ICD-9-CM) diagnosis codes from bills (claims) that hospitals and providers submit to payors or encounter records that HMOs use to track patient care to organize the diagnostic evaluative data items. Those skilled in the art will appreciate that for other types of data, such as credit worthiness, other standards could be used to organize other types of evaluative data items. Alternatively, if a standard does not exist in the field being analyzed, a user can propose an organization scheme.

Returning to the health care example, for many individual ICD-9-CM codes, even in very large populations, there may be none or only a few occurrences of rare conditions.

Thus, the present invention creates larger groups of clinically homogeneous codes called DxGroups™ which are stored in database DX on storage device 05. Generally, each ICD-9-CM code maps to one and only one DxGroup™. Individuals with several diagnostic codes will generally map to several DxGroups™. For example, in diabetes, a separate DxGroup™ for Type 1 diabetes exists in database DX in addition to other diabetes designations. Those skilled in the art will appreciate that in other fields of analysis, classifications similar to DxGroups can be used to further organize the evaluative data items.

As seen in FIG. 2, grouper 22 takes ICD-9-CM codes from a member's diagnostic record information and maps each code into one (or in rare circumstances, two) of the DxGroups™ listed in database DX. In the health care embodiments shown, each member of a client organization has an individual member object MO created for him or her in member database MB. As diagnostic or pharmacy claims, or similar health care evaluative data items are submitted for a member the data contained therein are associated with the member object MO by grouper 22, with the appropriate grouping information noted and stored.

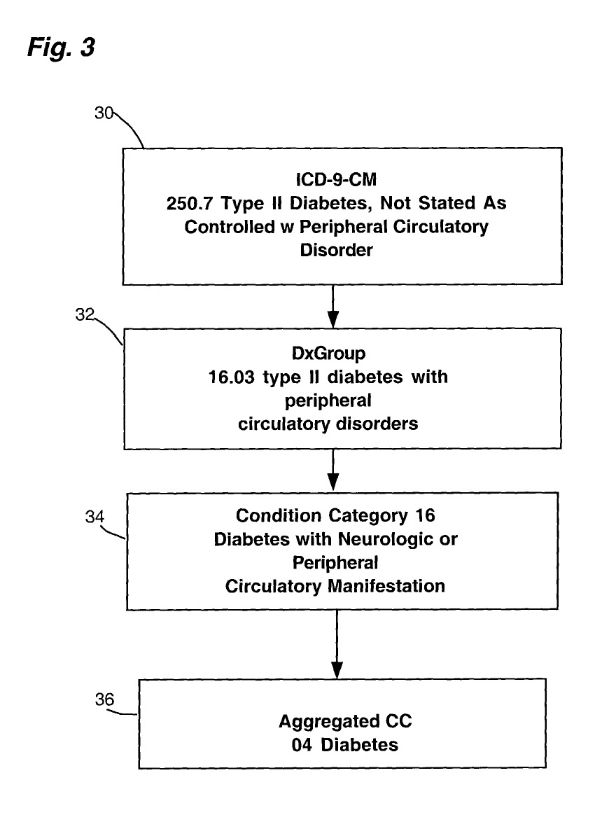

Still in FIG. 2, when requested either automatically, by the system or manually, by the user, modeler 24 performs multiple analyses of each member object MO to reach a final score and cost category for each member. For this purpose, modeler 24, for health care applications, organizes the DxGroups™ for a member into a smaller number of broader groups known as condition categories (CCs) for each member. When several related diagnoses are grouped into a condition category CC, the cost weight factors associated with that condition category CC are applied once to the one or more DxGroups™ and diagnoses for that individual. As FIG. 3 illustrates, a condition category CC may also be consolidated into aggregated condition categories ACC which describe even broader groups of diseases. In some cases, for some conditions, hierarchies of condition categories CC may be created. For prediction purposes, the more severe element or elements in the hierarchy would be the only condition category CC or condition categories CC's used for modeling the particular body system or condition when multiple condition categories CC's for the same condition might exist in the same patient. For example, a patient with both metastatic cancer and locally invasive cancer would be coded for only the metastatic cancer, while the person with locally invasive cancer and no metastatic cancer would receive modeling credit in the current invention for the locally invasive cancer.

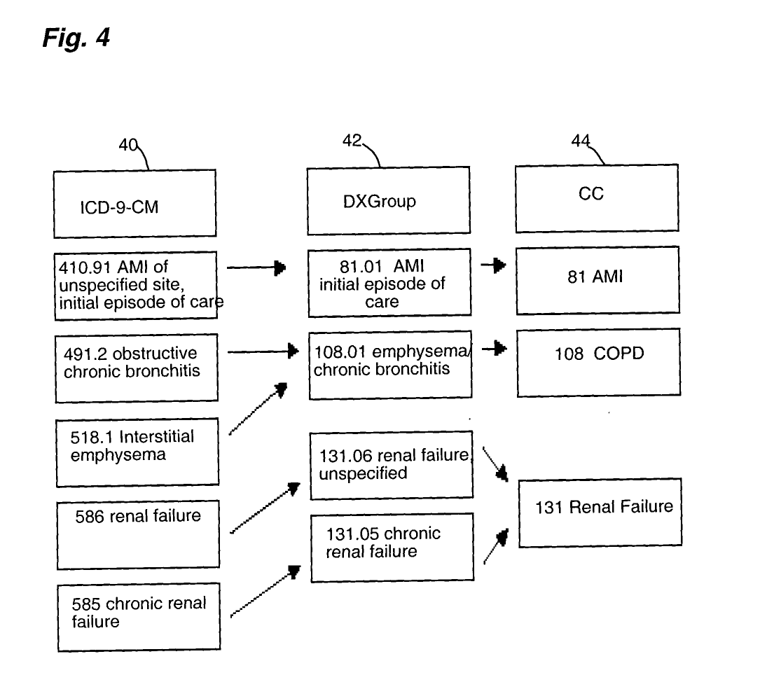

Turning now to FIG. 4, each condition category CC consists of DxGroups™ that are clinically related and similar with respect to levels of resource use, and hence predictable expense. Although most DxGroups™ map into only one condition category CC, a single person may have multiple condition categories CCs depending on the variety of his or her diagnoses, as illustrated in FIG. 4. Condition categories CCs are organized into broad body system or disease groups. For example, in the embodiments shown there are 6 condition category CCs for Infections, 8 for Neoplasms, and 6 for Diabetes and 4 for Metabolic Disorders. Such groups are indicated by condition category CC short names (e.g., Infection 1, Infection 2, . . . ). The numbering in this short name series generally indicates decreasing expected costs (e.g., Neoplasm 1 contains metastatic cancers and acute leukemias, Neoplasm 2 contains high cost specific cancers such as lung upper digestive tract and other severe cancers, Neoplasm 3 has other major cancers on down to Neoplasm 8, consisting of benign neoplasms of skin, breast and eye). As will be apparent to those skilled in the art, other names and groupings can be used for condition categories CC without deviating from the present invention.

As seen in FIG. 4, a member with the five individual diagnoses in column 40, will already have been grouped by grouper 22 into 4 DxGroups™. Modeler 24 groups the DxGroup™ categories into, in this case, three condition categories CCs.

In the embodiments shown, modeler 24 can further collapse the condition categories CC into 30 aggregated condition categories (ACCs). Aggregated condition categories ACCs are broadly defined (Diabetes, Heart, Vascular, Neonates, Screening/History, etc.) and are useful for profiling or presenting summarized analyses. Often aggregated condition categories ACCs are the first step in identifying the clinical conditions driving an observed relative risk score. They can be used to focus additional “drill-down” analysis to the condition category CC or DxGroup level of detail. As will be apparent to those skilled in the art, similar re-classifications into aggregated classifications or hierarchies can be defined for other types of evaluative data.

Returning to FIG. 2, in the embodiments shown, modeler 24 uses interaction terms IT and timing terms MT, from databases and procedures stored on storage device 05 to refine the predictive results. In the embodiments shown, interaction terms IT are data structured in table format which modeler 24 uses to create additional classifications or hierarchies. While the embodiments shown use table formats, those skilled in the art will appreciate that other formats, such as linked items in a database, could be used without deviating from the present invention. For health care purposes, interaction terms IT can describe interactions between demographic data, diseases, pharmacy data, laboratory data, survey data, and other descriptive health care data.

For example, in health care it is known that certain disease conditions which occur together in the same patient often lead to higher costs and resource use than either condition alone might. Diabetes and heart conditions in the same patient, for example, are likely to have such complicating interactions. The present invention enables experienced clinicians to describe such combinations or hierarchies or similar classifications of disease conditions and (in the presence of supporting empirical evidence) assign cost and weight factors to them.

This ability to include non-linear, clinical data from experienced practitioners significantly increases the accuracy and stability of the results produced with the present invention. When modeler 24 finds one of the condition categories diagnosed for a member in an interaction table, it can check to see if other condition categories diagnosed for that member are associated with it in the hierarchies specified in the interaction terms IT.

As mentioned, the disease hierarchy interaction terms IT structures improve the clinical validity and decrease the sensitivity to over-coding in the models. In the embodiments shown, disease hierarchies are made up of two or more related condition categories CC to create hierarchical condition categories HCCs—the collection of clinical elements that make up the granular units used when applying model weights. The hierarchical condition categories HCCs in a Disease Hierarchy are grouped into sub-hierarchies. Sub-hierarchies are medically based organizational units that describe a clinical attribute within a disease hierarchy. The sub-hierarchies are simple or complex in construct. A simple hierarchy is a straight-line arrangement where each hierarchical condition category HCC supersedes the hierarchical condition category HCC below it in the hierarchy. Elements of a simple hierarchy closer to the top are associated with increasing severity of the clinical disease process.

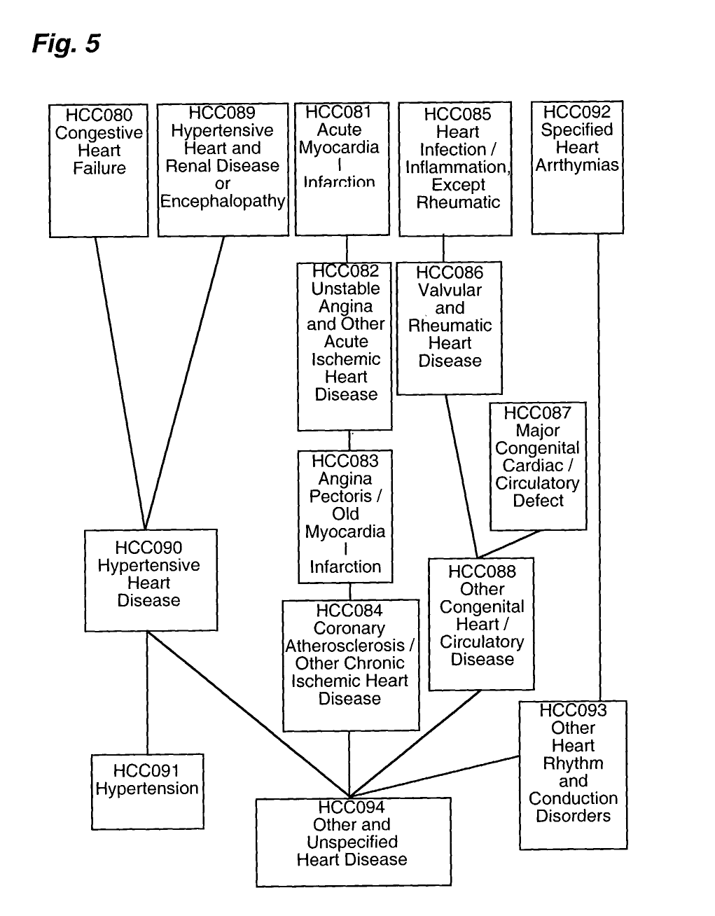

The cancer or neoplasm hierarchy is an example of a simple hierarchy with its eight elements ranging from a benign tumor of the skin, breast or eye at the floor to metastatic cancer or acute leukemia at the apex. Complex hierarchies are a collection of single hierarchical condition category HCCs and/or simple hierarchies that more completely describe a disease or a subunit of a disease. Relations between hierarchical condition categories HCCs in a complex hierarchy may be subordinate or peer. When relations are peer in nature, they add together to fully describe the total burden of the disease. The Heart Hierarchy shown in FIG. 5 is a good example of a complex hierarchy with its 15 hierarchical condition categories HCCs.

Or, as seen below, a simple example of a diabetic hierarchical condition category HCC is shown:

| ICD-9-CM | DxGroup | CC | HCC |
|---|---|---|---|
| 250.13 IDDM: | 17.02: Type 1 | 17: Diabetes with | 17 |
| uncontrolled, with | Diabetes with | Acute | |
| ketoacidosis | Ketoacidosis or | Complications | |
| | Coma | | |
| 250.01: IDDM, not | 19.02: Type 1 | 19 Diabetes with | — |
| stated as | Diabetes without | No or Unspecified | |
| uncontrolled, without | Complications | Complications | |
| mention of | | | |
| complications | | | |

The diagnosis of complicated diabetes for a specific patient supersedes the diagnosis of uncomplicated diabetes for that same patient. That is to say, recording a diagnosis of uncomplicated diabetes when the diagnosis of complications is present adds nothing to predicted costs.

An advantage of this approach is that it tends to reduce (or fails to reward) what is known alternatively as coding creep, upcoding, or gaming—various techniques providers might use to make a patient appear sicker than he or she is.

Timing terms MT are also stored in database tables in storage device 05. A timing term MT as used with the present invention generally means some form of absolute or relative time element or time period that can further refine the predictive power of the present invention. For example, it is known that children who have at least three ear infections within a twelve—month period (such as member PA1 from FIG. 1) may be likely candidates for having tubes inserted in the ear in the near future. Since this is a procedure with associated expense, if modeler 24 discovers that a member has had three or more ear infection diagnoses within a twelve month period, modeler 24 can determine from the timing terms that this frequency suggests an additional expense for the tubes will be likely within the next 12 month period and a corresponding hierarchical condition category HCC or similar category can be assigned to the member to supersede the simple ear infection diagnosis as a cost/weight factor.

Similarly, the relative time at which a diagnosis is made can affect the expected future expense for a patient. For example, if an otherwise healthy member is diagnosed with a fractured shoulder in Q1, of the year being analyzed, but no other diagnostic or pharmacy expenses show up for that member in the next three quarters, the probability is good that expenses may be lower next year for that member. On the other hand, if a female member aged 62 has a diagnosis of hip fracture in Q4, together with a COPD pulmonary complex of diagnoses, she may be more likely to have higher expenses in the coming year, particularly in Q1 of the coming year. The predictions might also be influenced by the occurrence and timing of the other information, such as COPD, or other injuries to the same person. Timing terms MT are thus used to adjust the member's predictions accordingly, based not only on the existence of certain evaluative data but also its timing. For example, knowledge of the existence of diabetes with renal manifestation throughout the year, based on the timing of the diagnoses stored in the database of the present invention may indicate a different level of severity for the patient, than if the diagnosis was only seen during the last 3 months or fourth quarter of the year.

The use of timing terms MT by the present invention also enables modeler 24 to perform trend analyses. Heretofore, modeling systems simply used a fixed year of data to predict costs/resources/payments for the coming year or the current year. Timing terms MT enable the invention to provide a rolling 12 month forecast or use a smaller time sample size, such as 6 months or even 3 months for predictions. That is, the trend analysis function can operate recursively, that is, an analysis for a specified period can make use of the results of an analysis for an earlier period.

As another example of the use of timing terms MT, if the present invention is used to predict ongoing expenses associated with newborns, days since birth would be the appropriate timing unit rather than quarter of year increments.

As mentioned above, the present invention also allows the incorporation and use of pharmacy data for analysis and prediction of health care costs. Pharmacy data is usually reported electronically to the client organization for claims adjudication in what is much closer to real time than the reporting of diagnostic data. Similarly, laboratory and survey data, which can also be used by the present invention, are typically available closer to real time than are claims transactions. In addition, lab and survey data capture different nuances of the impact of conditions on the patient, often adding dimensions of severity to the diagnostic data. For example, the laboratory blood test that measures creatinine is a measure of kidney function. A condition category CC for diabetes with renal manifestations would potentially describe a patient with more severe disease, and therefore higher expected costs, if the diagnosis occurred in conjunction with an elevated creatinine level.

As another example, if a child is diagnosed for the first time as a Type I diabetic and prescribed insulin, the pharmacy prescription claim is likely to be presented to the HMO or other client organization for payment within a few hours or at most, days, of the diagnosis. The primary care provider may not file his or her diagnostic report/claims for months after the diagnosis is made, sometimes as much as six months or longer.

However, while the pharmacy data is more timely for predictive purposes, it can also be quite ambiguous. Many drugs are used for multiple purposes, so it is not obvious, in many cases, for which diagnosis a particular drug is being prescribed.

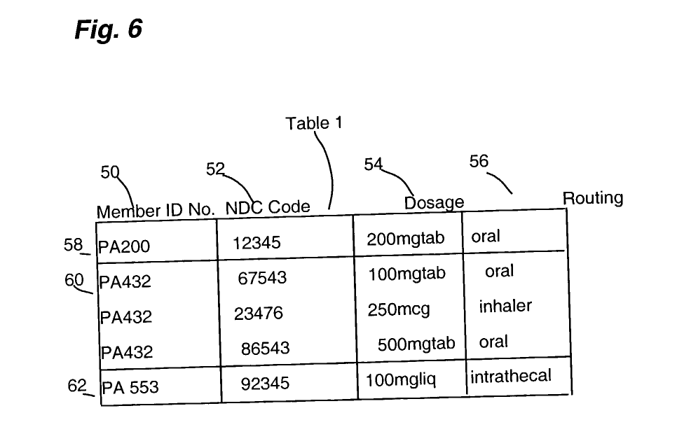

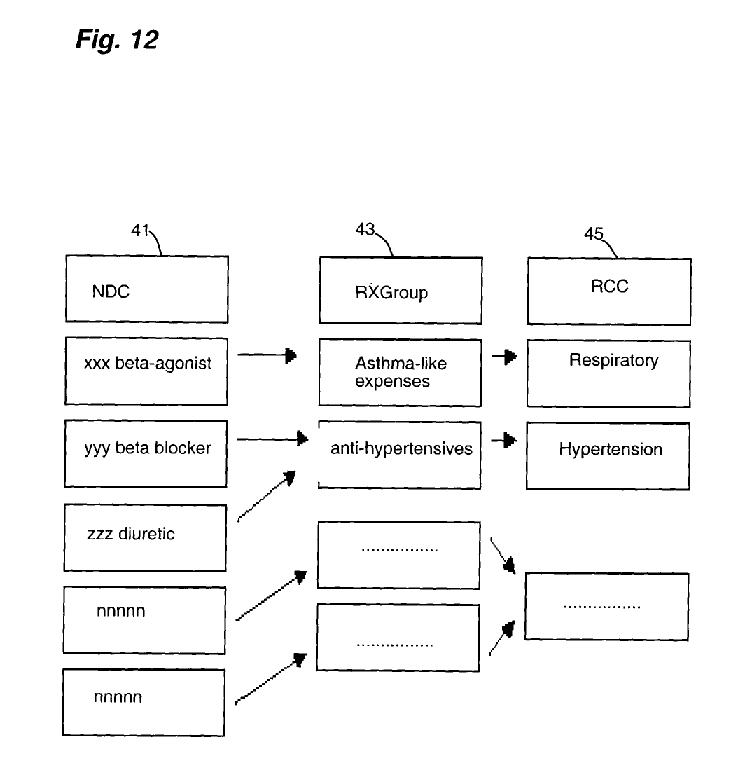

In the embodiments shown, the present invention accepts pharmacy data that includes a National Drug Code and dosage and routing information as shown in FIG. 6. Grouper 22 of the present invention takes information about drug codes from the pharmacy input claims data and compares it to database RX, containing the details of the NDC drug description. That basic information along with the dosage and routing information is stored by grouper 22 according to each member ID number, in the appropriate member object MO record or file. As seen in FIG. 12, in the embodiments shown of the present invention, the drug code and dosage and routing information are grouped into RxGroups™, which use drug classes alone to predict health care costs. Additionally, pharmacy data may be used in conjunction with diagnostic information to predict health care costs.

In the health care embodiments shown of the present invention, both interaction terms IT and timing terms MT also include interactions, hierarchies and relationships related to pharmacy information. For example, it is well known in clinical practice that for patients with asthma, there are several different types of inhaled medications a patient may take. These may be grouped in a hierarchy, with the lowest suggesting a mild condition and the highest indicative of a severe disease burden. Still in FIG. 6, at row 60 of Table 1, it can be seen that member ID number PA432 has been given three prescriptions on the same day, one of which, NDC number 23476 (hypothetical not actual NDC numbers are used here) is an inhaler for the most severe class. On this basis, member ID number PA432's diagnosis can be presumed to be the most severe form of asthma and the appropriate drug class condition category CC or Hierarchy Condition Category HCC can be ascribed to it for prediction.

As another example, assume that the NDC number 92345 is a prescription for a benzodiazapine, normally prescribed as a tranquilizer. However, it is known that when it is administered intrathecally, i.e. injected through the spinal cord, it is being prescribed to treat spasticity or muscle rigidity associated with a more severe diagnosis such as spinal cord injury, stroke, cerebral palsy, or head injury. Thus, this pharmacy data is indicative of a more severe diagnosis, and hence the likelihood of higher costs associated with it.

As still another example of the use of interaction terms IT and timing terms MT, and still in FIG. 6, it is known that amantadine, known as a flu drug, is usually prescribed in syrup form for younger patients with flu. However, when prescribed in higher doses and in tablet form it is usually prescribed for fatigue and multiple sclerosis for an adult patient. In seniors, it is once again more commonly, even in the tablet form, used to treat influenza. The medication can also be used to counteract effects of some psychiatric medications. Thus, the interaction of dosage and routing evaluative data items along with demographic evaluative data items derived from the member ID number can distinguish a pediatric case from a more severe adult diagnosis and also from a less severe geriatric diagnosis.

Other interaction terms IT are also constructed for pharmacy data, based on the chemical analysis of the prescribed drug. In addition, drugs can be grouped by clinical and quantitative effects, as well. Analgesics can be grouped as narcotic and non-narcotic, antidepressants can be separated into SSRI's versus other antidepressants, and so forth. Anti-infectives can be grouped into those predicting low and high medical cost, such as penicillin versus Ciprofloxacin, for example.

Modeler 24, using interaction terms IT and timing terms MT for such pharmacy data will associate concomitant costs and weights for them in the member's member object MO record.

An additional advantage of this use of pharmacy data in interaction terms IT and timing terms MT is that sentinel interactions can be searched for as well. For example, modeler 24 could be instructed to search for multiple occurrences within a specified time period of prescriptions for Ciprofloxacin or other powerful anti-infectives within a group or population. Such sentinel data might provide early warning of an epidemic or of a disruption such as that caused by the anthrax threats of 2001, and a means for predicting the associated costs.

Similarly, an increase in prescriptions for beta blockers in a certain demographic group might provide more immediate warning of cost increases likely to come from that group, perhaps due to patients having new heart attacks for which claims have not yet been submitted.

The present invention also allows a client organization to obtain much better and faster information on Incurred But Not Reported (IBNR) costs. Heretofore, although modeling costs using pharmacy data might have been available to some client organizations, the inability to use interaction terms IT and timing terms MT made it difficult or in some cases, impossible, to use such information reasonably accurately for IBNR purposes.

Although the pharmacy data might have been available to some client organizations, without some way to associate it properly with a likely cost, diagnosis, or severity of illness, it was only an alert that something might come in within a few months' time. Most client organizations using generally accepted accounting principles (GAAP) accrue incurred but not reported expenses in their financial statements and reports to avoid over (or under) stating earnings. With a typical lag of several months of reporting time between the date a physician makes a diagnosis and the date on which the claims are filed by the physician or provider, estimates of IBNR have traditionally been subject to large variation. Thus, any increase in the accuracy of estimating incurred but not reported expenses is extremely valuable. The IBNR calculation is necessary to calculate the correct amount of withhold reserve funds needed to cover the expenses that have already occurred, but that are unknown. Accurately predicting IBNR can have a substantial affect on how much profit a company can post, while still adhering to GAAP.

The ability to use nearer to the time of diagnosis concurrent information which is reported at the same time, or near the time a diagnosis is made, such as pharmacy data, administrative utilization and referral approval, survey, and/or laboratory data with the appropriate interaction terms IT and timing terms MT applied by the present invention, now makes it possible to know likely IBNR amounts much more accurately and more quickly than ever before. As mentioned earlier, it may take months for the diagnostic information to be reported. However, the above types of concurrent information are often reported much nearer to the time when a diagnosis is made—usually well before the diagnosis itself is reported. In some cases, this concurrent information may be reported within a day or two of the day of diagnosis, as often happens with pharmacy prescription information. In other cases, laboratory or referral or similar information may be reported within a few days, or weeks of the diagnosis. Thus, the present invention can create benchmark data, interaction terms, and timing terms around concurrent information in order to predict expenses. The modeling system allows for creation of models that incorporate elements of both long and short term horizons, with high and low frequency components reflecting acute and chronic health care needs and utilization.

The timeliness of such data can also be used to manage care more efficiently. A client organization may have several insured groups for which it is the payor. If it has recently added a new group for coverage, it is possible that this new group may be “sicker” than the average groups in the organization. That is, for whatever reasons, its members may have a higher incidence of disease than the other groups. For a new group, the client organization using older techniques may not realize this until the first year of coverage/eligibility is nearly over.

However, using the present invention, and in particular, using modeler 24 and the interaction terms TT and timing terms MT together with the pharmacy data and/or laboratory data, it may be possible for the client organization to see in two to three months that incurred but not reported expenses for this group are higher for Q1 than for all the other groups in its coverage. Similarly, it is possible that a new group may be much healthier than average, and hence projections can be wrong for that reason, too. In either case the ability to use the functions of the present invention with the pharmacy data, laboratory data, and other data sources along with interaction terms TT and timing terms MT makes it much easier for the client organization to detect financial shortfalls or surpluses and report and manage them more accurately.

Additionally, the present invention also provides more useful information for underwriters. While historically, an underwriter uses standard demographic data to determine whether or not to extend coverage to a new group, renewals are a different matter. Having diagnostic, pharmacy, laboratory and/or survey data about an existing group, together with trend analysis capability, gives the underwriter a much more accurate way to analyze renewals.

Heretofore an underwriter might look at last year's expenses for a group and apply a standard cost increase factor of, say, 10 percent and raise premiums accordingly. Simply looking at total expenses for the past year does not give the underwriter a sense for how healthy or sick the population is. For example, if most of the members are young and healthy but had an unusual number of emergency room procedures for accidents, that does not suggest there is an increased risk for higher resource use in that population and a premium increase might cause such a group to go elsewhere for medical insurance coverage.

Renewals can also be a problem if the renewal period occurs before the underwriter has a full year of data to analyze in its traditional manner. For example, a new employer group may have joined in March of a calendar year and the underwriter must prepare the renewal in November, well ahead of the renewal date. With traditional modeling techniques, there would not be enough reliable information available to the underwriter in that time period to make a realistic renewal assessment based on the health status of the group. However, with the present invention, using pharmacy data, laboratory data, or survey data, along with interaction terms IT, and timing terms MT, the underwriter has much more information available, even in such a short time period, with which to make a more realistic assessment about renewal.

Returning again to FIG. 2, for each individual and user defined group, the predictions of modeler 24 are presented in two formats—relative risk scores and DCG categories:

1. Relative Risk Scores (RRS) describe each individual's expected resource use normalized to a mean score of 1.00. In health care, this relative risk score may be interpreted as a measure of expected relative cost, or as a “health status measure” based on expected expenditure differences in comparison to the average of a benchmark population in benchmark database B1. Depending on the model and population, predictions for individuals may range from as little as eight percent of the average to over 146 times the average (that is, with RRS from 0.08 to over 146.00).
2. DCG Categories indicate not the relative, but the absolute level of predicted expenses at the individual-level. The number associated with each category marks the low end of the prediction interval in thousands of dollars. For example, in the embodiments shown, DCG category 5 contains people whose predicted cost in Year 2 is between $5,000 and $6,000 (the lower bound of the next predictor interval). Similarly, this might apply somewhat differently in other areas. For example, the table below shows the DCG categories and expenditure levels for predictions:

| DCG | |
|---|---|
| Category | Predicted Expenditure Interval |
| 0.0 | $0 to $99 |
| 0.1 | $100 to $199 |
| 0.2 | $200 to $299 |
| 0.3 | $300 to $399 |
| 0.4 | $400 to $499 |
| 0.5 | $500 to $699 |
| 0.7 | $700 to $999 |
| 1 | $1,000 to $1,499 |
| 1.5 | $1,500 to $1,999 |
| 2 | $2,000 to $2,499 |
| 2.5 | $2,500 to $2,999 |
| 3 | $3,000 to $3,999 |
| 4 | $4,000 to $4,999 |
| 5 | $5,000 to $5,999 |
| 6 | $6,000 to $6,999 |
| 7.5 | $7,500 to $9,999 |
| 10 | $10,000 to $14,999 |
| 15 | $15,000 to $19,999 |
| 20 | $20,000 to $24,999 |
| 25 | $25,000 to $29,999 |
| 30 | $30,000 to $39,999 |
| 40 | $40,000 to $49,999 |
| 50 | $50,000 to $59,999 |
| 60 | $60,000 to $69,999 |
| 70 | $70,000+ |

In the embodiments shown, modeler 24 also can produce predictions based on Aggregated DCG (ADCG) categories for all DCG models. ADCG 25 would be used to count the number of individuals expected to cost more than $25,000, for example. Five ADCG intervals are shown below:

| ADCG | Predicted Expenditure Interval |
|---|---|
| 0 | $0 to $999 |
| 1 | $1,000 to $4,999 |
| 5 | $5,000 to $9,999 |
| 10 | $10,000 to $24,999 |
| 25 | $25,000+ |

Modeler 24, in the health care embodiments shown, uses linear, additive formulas obtained from Ordinary Least Squares (OLS) regressions to combine the expenses associated with evaluative data items such as diagnostic groupings (HCCs), age/sex cohorts and other demographic factors. Each diagnostic category, age/sex cohort, and demographic category contributes a cost weight to the final prediction. User client organizations need not run any regressions as the benchmark databases are provided with the system. In the health care embodiments, the invention applies the benchmarked cost weights to the client organization's member evaluative data items. As mentioned above, use of other factors, data or modeling techniques (for example, neural network techniques, other linear regression techniques, transformation techniques, categorical techniques, probability techniques, logit techniques and higher-order non-linear techniques) for deriving the benchmark data cost weights are possible without deviating from the spirit of the invention.

Turning again to FIG. 2, it can be seen that reporter 26 of the present invention (in combination with modeler 24) enables the user client organization to request reports and analyses in a number of different ways. For example, a user can request concurrent models, which use Year 1 or current period diagnostic (or survey, or laboratory or pharmacy, etc.) information to predict Year 1 or current period expenditures. These are useful for physician profiling, employer reporting, or performance analysis as well as for incurred but not reported expenses. A user can also request prospective explanation models, which use Year 1 or current period diagnostic (or survey, or laboratory or pharmacy, etc.) information to predict Year 2 or next period expenditures. These are useful for risk analysis and care management. Prospective payment models use Year 1 diagnostic information to develop Year 2 health-based payments and budgets. Unlike explanation models, payment models consider financial incentives resulting from the model. For example, vague and/or discretionary codes (such as “cough”) are not used to set payments due to concern that providers would “over-code” coughs. Users can also request truncated models (those which eliminate expenses above a certain level) to better differentiate health care resource use in relatively healthy populations.

In health care applications, the reports produced by the present invention are useful in provider profiling. Applying the DCG™ models as a case-mix adjuster addresses concern that some patient populations may be older and sicker than others. In addition, detail at the DxGroup™ and Condition Category levels is helpful for profiling physician practice patterns and for understanding the clinical conditions that drive relative risk scores. The methods of the present invention can be used to more accurately describe the costs associated with particular episodes of care. Using a description of the patient's underlying health burden (modeled using the system and method of the present invention incorporating interaction terms IT and timing terms MT) the expected cost of an episode of care will be more clearly defined. A relatively healthy person receiving a cardiac bypass operation has a lower expected cost for the episode of bypass than a patient with multiple chronic medical conditions.

Concurrent (also called retrospective) DCG models can be used for case-mix adjustment. In the health care embodiments shown, the concurrent models have coefficients (or cost weights) for minor trauma and episodic conditions. While these conditions do not predict extra costs in future years, they are associated with higher costs in the year in which they occur.

If reinsurance or stop loss is in place or there is concern about the impact of high cost “outliers” on profiles of physicians with small panels, truncated model reports can be requested. For example, in the embodiments shown, reports can be issued for one of three possible thresholds: annual expenditures of $25,000, $50,000, or $100,000. Those skilled in the art will appreciate that different or additional thresholds can be used without deviating from the spirit of the invention.

As for reviewing provider group performance, reports generated by the present invention may help to more accurately identify good practices and providers. In the example below, provider groups within an Integrated Delivery System of a client organization have large differences in the observed expenses. Provider Group D has the lowest cost and Provider Group E has the highest cost. However, the provider groups see very different types of patients. Provider D has a very young and healthy population (relative risk score 0.61). Provider Group E has an older population that appears to be relatively ill (relative risk score 1.52).

### Actual Expenditures and Relative Risk Scores

| | | Provider | Provider | Provider |
|---|---|---|---|---|
| | Total | Group A | Group D | Group E |
| Actual Expenditures | $1,263 | $1,366 | $1,058 | 2,176 |
| Age/Sex Relative risk | 1.00 | 1.15 | 0.64 | 1.22 |
| score | | | | |
| Health Relative risk | 1.00 | 1.16 | 0.61 | 1.53 |
| score | | | | |

The relative risk scores (from above) are used to calculate predicted expenditure as seen below. Observed expenses are compared to predicted expenditures (an O/E ratio) to create an efficiency index. Provider Group D's observed expense is $1,058, but its expected expense (based on the relative risk score) is only $770. The efficiency index of 1.37 indicates that costs of Provider Group D were 37% more than anticipated. On the other hand, Provider Group A's observed expense is $1,366, but its expected expense is $1,465. The observed/expected ratio (an O/E ratio) of 0.93 indicates that Provider Group A costs 7% less than expected.

### Observed Expenditures Compared to Expected Expenditures

| | | Provider | Provider | Provider |
|---|---|---|---|---|
| | Total | Group A | Group D | Group E |
| Observed Expenditure | $1,263 | $1,366 | $1,058 | $2,176 |
| Predicted Expenditure | $1,263 | $1,465 | $770 | $1,920 |
| Observed/Predicted | 1.00 | 0.93 | 1.37 | 1.13 |
| Expenditure | | | | |
| Efficiency Scores | | | | |

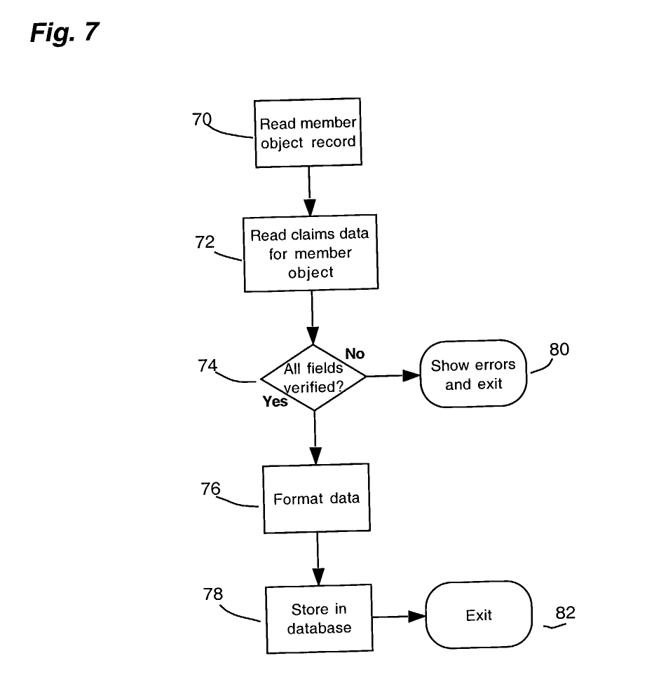

Now turning to FIG. 7, a flow diagram of the importer function of the present invention is shown. At step 70, importer 20 reads a member object MO record from database MB (or, if this is the first time information about his member is provided, importer 20 creates a member object record in database MB for that member.) Next, at step 72, importer 20 reads any new evaluative data associated with this member. In the health care embodiments shown, this could be diagnostic data or pharmacy data or laboratory data or survey data, etc. Those skilled in the art will appreciate that other types of evaluative data can be used for other applications without deviating from the spirit of the present invention. Similarly, while importer 20 performs the auxiliary task of organizing and verifying the data, those skilled in the are will appreciate that the present invention can also work with data that has already been verified and organized.

At step 74 importer 20 verifies that all fields are correct. If they are not, an error is indicated at step 80 and processing for this member stops.

Next, at step 76, the verified, evaluative data items for the member are formatted for the database used and at step 78, they are stored in the database. When this is complete, processing exits at step 82.

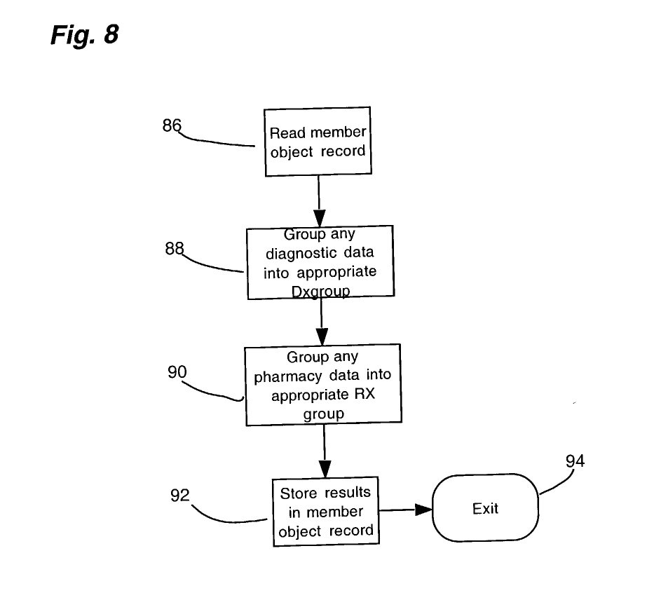

Turning now to FIG. 8, a flow diagram for grouper function of the present invention is shown. At step 86, grouper 22 reads the member object MO record which has been updated with new evaluative data items. At step 87, grouper 22 applies the cost weight factors from benchmark database B1 to each new evaluative data item for this member. The next steps 88 and 90 are illustrative of groupings for health care applications in which evaluative data items are grouped into Dxgroups if diagnostic data is available or RxGroups™ if pharmacy data is available. The results of any groupings done are stored in the member object MO record in database MB at step 92 and processing exits at step 94.

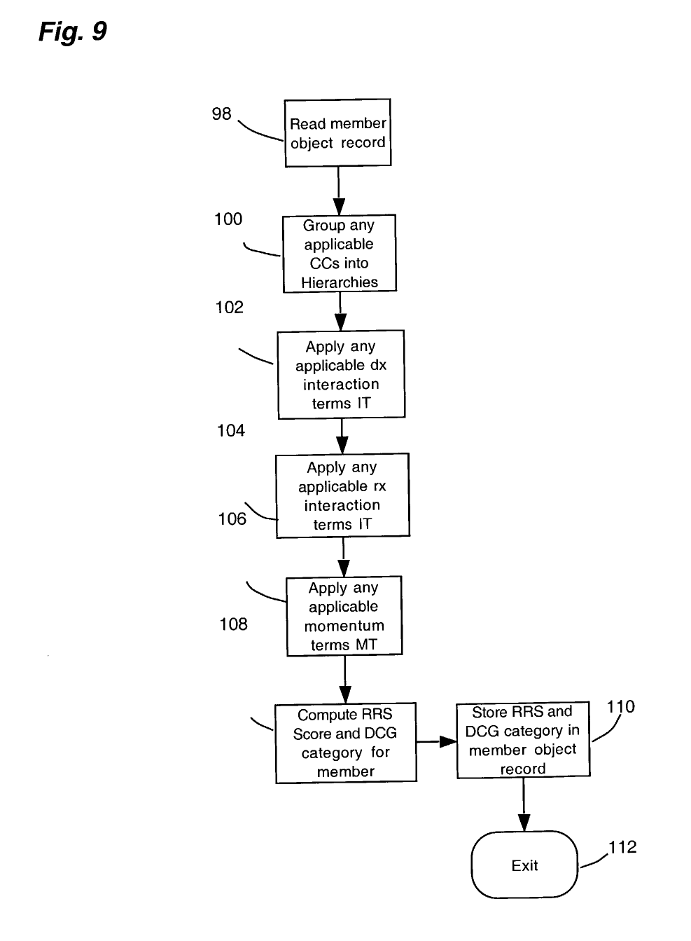

With reference now to FIG. 9, a flow diagram of the modeler function of the present invention is shown. At step 98, modeler 24 reads an updated and grouped member object MO record from database MB. In health care applications, steps 100-104 are performed to perform further grouping into hierarchies (step 100), apply applicable diagnostic (or other) interaction terms IT (step 102) and apply any applicable pharmacy interaction terms IT such as dosing and routing data (step 104). Then at step 106 timing terms MT are applied. Modeler function 24 computes RRS scores and DCG categories (or their counterparts for non-health care applications) at step 108 and stores them in member object MO record in database MB at step 110. Processing exits at step 112.

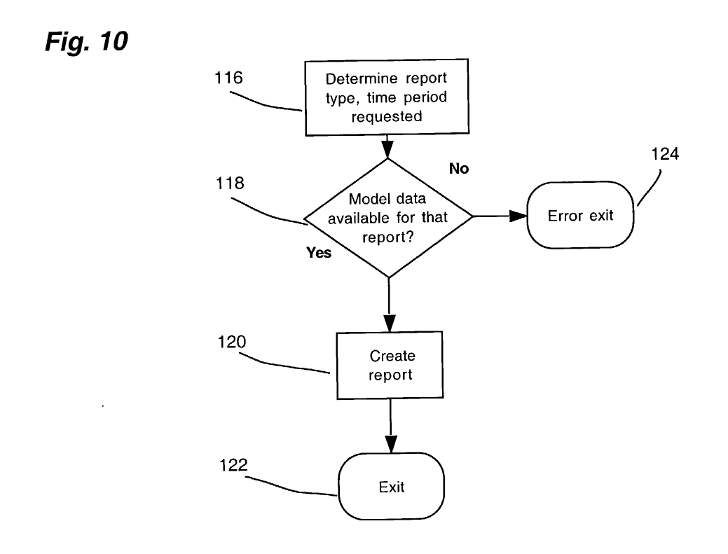

In FIG. 10, a flow diagram of the auxiliary reporter function task is shown. At step 116, reporter 26 determines from user supplied input data which report type is being requested and for what time periods and groups or sub groups of the client member organization. At step 118, reporter 26 checks member database MB to see if model data is available for that report. If it is not, an error is noted and processing exits at step 124. If the data is available, a report is created at step 120 and processing exits at step 122.

Those skilled in the art will appreciate that the reports can be presented in any of a number of formats, ranging from printed reports with relatively raw data, to electronic formats, charts, graphs, web pages, etc. Similarly, the type of report can vary as described above from concurrent reports to predictive reports, payment reports, IBNR reports, etc.

In the embodiments shown, the present invention is implemented using Microsoft Corporation's Visual Studio Development Environment and the C-Sharp language. The database used in the embodiments shown is Microsoft Corporation's SQL Server™ database software on the Windows™ operating system, but as will be apparent to those skilled in the art, it could also be implemented in any of a number of programming languages such as JAVA, C, C++, assembler, ADA, Pascal, and any number of operating systems, such as Unix or Linux, for example, and any number of database products or structures, such as Oracle Corporation's Orade™ database or IBM's DB2™ database. The embodiments shown are illustrated being used by a single client organization at a single site. However, those familiar with the SQL Server™ software are aware that it can be scaled to operate as a web-enabled application, or as a distributed application. Similarly, while the embodiments shown use software programs and relational databases to implement the invention, those skilled in the art know that some or all of the present invention could also be implemented in firmware or circuitry without deviating from the spirit of the present invention. Similarly, other types of files or databases could be used without deviating from the present invention. Those skilled in the art will appreciate that the embodiments described above are illustrative only and that other systems in the spirit of the teachings herein fall within the scope of the invention.

What is claimed is:

1. A system for health care costs and outcomes modeling for members of a defined subject population, comprising:
benchmark data containing derived cost weights for evaluative data items including pharmacy prescription information containing dosage and routing data along with demographic data, the benchmark data being created by subjecting evaluative data item information about a pre-defined benchmark population to an analytical technique to derive cost weights and storing the derived cost weights for each evaluative data item in a database;
interaction term data stored in the database, for identifying specified combinations of evaluative data items having incremental cost weights;
a grouper function for applying the applicable cost weights to each defined subject population member's associated evaluative data items using cost weights from the corresponding evaluative data items in the benchmark data, the grouper function also grouping the evaluative data items into pre-determined classifications; and
a modeler function for performing any further grouping into any other classifications, the modeler function applying interaction terms as appropriate to create any aggregated classifications and to calculate and store predictive scores and cost estimate categories for each member.

2. The system of claim 1, wherein the interaction term data further comprises pre-defined combinations of dosage and routing information.

3. The system of claim 1, wherein the interaction term data further comprises pre-defined combinations of dosage and routing information with demographic data.

4. The system of claim 1, wherein the interaction term data further comprises pre-defined combinations of dosage and routing information with chemical properties of prescribed drugs.

5. The system of claim 1, wherein the interaction term data further comprises pre-defined combinations of dosage and routing information with clinical effects of prescribed drugs.

6. The system of claim 1, wherein the interaction term data further comprises pre-defined combinations of dosage and routing information with quantitative effects of prescribed drugs.

7. A system for health care costs and outcomes modeling for members of a defined subject population, comprising:
benchmark data containing derived cost weights for evaluative data items including pharmacy prescription information, the benchmark data being created by subjecting evaluative data item information about a pre-defined benchmark population to an analytical technique to derive cost weights and storing the derived cost weights for each evaluative data item in a database;
interaction term data stored in the database, for identifying specified combinations of evaluative data items having incremental cost weights;
timing term data stored in the database, for identifying timing information about evaluative data items having incremental cost weights;
a grouper function for applying the applicable cost weights to each defined subject population member's associated evaluative data items using cost weights from the corresponding evaluative data items in the benchmark data, the grouper function also grouping the evaluative data items into pre-determined classifications; and
a modeler function for performing any further grouping into any other classifications, the modeler function applying interaction terms as appropriate to create any aggregated classifications and applying timing terms as appropriate to the classifications to calculate and store predictive scores and cost estimate categories for each member.

8. The system of claim 7, wherein the modeling function further comprises applying interaction term data and timing term data to search for sentinel interactions in which a number of prescriptions for drugs of a specified type are made in a specified time period.

9. The system of claim 7, wherein the modeling function further comprises a trend analyzer function for using timing term data to analyze trends over a specified time period.

10. The system of claim 7, wherein the trend analyzer further comprises a recursive function capable of using results from a previous trend analysis.

11. A method for health care costs and outcomes modeling for members of a defined subject population, comprising the steps of:
creating benchmark data containing derived cost weights for evaluative data items including pharmacy prescription information containing dosage and routing data along with demographic data, the benchmark data being created by subjecting evaluative data item information about a pre-defined benchmark population to an analytical technique to derive cost weights and storing the derived cost weights for each evaluative data item in a database;
using interaction term data stored in the database, for identifying specified combinations of evaluative data items having incremental cost weights;
applying the applicable cost weights to each defined subject population member's associated evaluative data items using cost weights from the corresponding evaluative data items in the benchmark data, the grouper function also grouping the evaluative data items into pre-determined classifications; and
modeling by performing any further grouping into any other classifications, the modeler function applying interaction terms as appropriate to create any aggregated classifications and to calculate and store predictive scores and cost estimate categories for each member.

12. The method of claim 11, wherein the step of using interaction term data further comprises the step of using pre-defined combinations of dosage and routing information.

13. The method of claim 11, wherein the step of using interaction term data further comprises the step of using pre-defined combinations of dosage and routing information with demographic data.

14. The method of claim 11, wherein the step of using interaction term data further comprises the step of using pre-defined combinations of dosage and routing information with chemical properties of prescribed drugs.

15. The method of claim 11, wherein the step of using interaction term data further comprises the step of using pre-defined combinations of dosage and routing information with clinical effects of prescribed drugs.

16. The method of claim 11, wherein the step of using interaction term data further comprises the step of using pre-defined combinations of dosage and routing information with quantitative effects of prescribed drugs.

17. A method for health care costs and outcomes modeling for members of a defined subject population, comprising:
creating benchmark data containing derived cost weights for evaluative data items including pharmacy prescription information, the benchmark data being created by subjecting evaluative data item information about a pre-defined benchmark population to an analytical technique to derive cost weights and storing the derived cost weights for each evaluative data item in a database;
using interaction term data stored in the database, for identifying specified combinations of evaluative data items having incremental cost weights;
using timing term data stored in the database, for identifying timing information about evaluative data items having incremental cost weights;
applying the applicable cost weights to each defined subject population member's associated evaluative data items using cost weights from the corresponding evaluative data items in the benchmark data, the grouper function also grouping the evaluative data items into pre-determined classifications; and
modeling by performing any further grouping into any other classifications, the modeler function applying interaction terms as appropriate to create any aggregated classifications and applying timing terms as appropriate to the classifications to calculate and store predictive scores and cost estimate categories for each member.

18. The method of claim 17, wherein the step of modeling further comprises the step of applying interaction term data and timing term data to search for sentinel interactions in which a number of prescriptions for drugs of a specified type were made in a specified time period.

19. The method of claim 17, wherein the step of modeling further comprises the step of using timing term data to perform trend analysis over a specified time period.

20. The method of claim 17, wherein the step of modeling further comprises the step of recursively using results from a previous trend analysis.
